(19) United States
(12) Patent Application Publication
(10) Pub. No.: US 2020/0255145 A1
(43) Pub. Date: Aug. 13, 2020

(54) SYSTEM AND METHOD FOR UNDERWATER DEPLOYMENT OF A PAYLOAD

(71) Applicant: Hybrid Robotics, Inc., Traverse City, MI (US)

(72) Inventors: Matthew Goddard, Williamsburg, MI (US); Aaron Botkee, Traverse City, MI (US); Clayton Harbin, Traverse City, MI (US); Ryan Mater, Traverse City, MI (US)

(21) Appl. No.: 16/775,652

(22) Filed: Jan. 29, 2020

Related U.S. Application Data
(60) Provisional application No. 62/803,953, filed on Feb. 11, 2019.

(51) Int. Cl. B64D 1/12; B63G 8/00; B64C 39/02

(52) U.S. Cl. CPC B64D 1/12; B63G 8/001; B64C 39/024; B64C 2201/146; B64C 2201/027; B64C 2201/128; B63G 2008/007

(57) ABSTRACT

A system and method for safely, efficiently and reliably deploying a payload, such as a remotely operated vehicle (ROV) beneath the surface of the water. The ROV is configured to capture data and/or information and to transmit the data and/or information to a base station. The system comprises an unmanned aerial system (UAS) having a frame comprising a support structure configured to receive the payload, wherein the payload may be deployed beneath the surface of water and a winch is configured to deploy the ROV from and retrieve the ROV back to the UAS using a tether. The tether is configured to wirelessly transmit telemetry, data, and/or information between the UAS and the ROV in real time.

### CROSS REFERENCE TO RELATED APPLICATIONS

The present application claims the benefit to U.S. Provisional Patent Application No. 62/803,953 filed on Feb. 11, 2019, and U.S. Provisional Patent Application No. 62/912,137, filed on Oct. 8, 2019, which are incorporated herein by reference in their entireties,

### FIELD

The present disclosure generally relates to a system and method for underwater deployment of a payload, such as a remotely operated vehicle.

### BACKGROUND

An unmanned system, which may also be referred to as an autonomous vehicle, is a vehicle capable of travel without a physically-present human operator. An unmanned system may operate in a remote-control mode, in an autonomous mode, or in a partially autonomous mode.

When an unmanned system operates in a remote-control mode, a pilot or driver at a remote location can control the unmanned vehicle via commands that are sent to the unmanned vehicle via a wireless link. When the unmanned system operates in an autonomous mode, the unmanned system typically moves based on pre-programmed navigation waypoints, dynamic automation systems, or a combination thereof. Some unmanned systems can operate in both a remote-control mode and an autonomous mode.

Various types of unmanned systems exists for various different environments. For example, unmanned aerial vehicles (UAVs), such as quad-copters, are configured for operation in the air. Remotely operated vehicles (ROVs) may be used to gain access to particular locations, such as deep ocean depths or offshore locations. However, current methods require a boat/helicopter/plane and/or a dive crew to complete offshore missions in many unsafe locations. As a result, these missions have safety concerns to pilots/divers and require significant time, cost, and resources.

Consequently, there is a need for a system that can safely, efficiently, and reliably conduct marine investigations and readily collect and transmit the associated data and information.

### SUMMARY

What is provided is a system and method for safely, efficiently and reliably deploying a payload, such as a remotely operated vehicle beneath the surface of the water. The ROV is configured to capture data and/or information and to transmit the data and/or information to a base station.

In an embodiment, the system includes an unmanned aerial system (UAS) having a support structure configured to receive a remotely operated vehicle (ROV), wherein the ROV is configured to deploy from the support structure on or beneath the surface of a body of water. The UAS also includes a winch configured to selectively deploy the ROV from the support structure using a tether comprising a first portion and a second portion, wherein the first portion of the tether is connected to the UAS and the second portion of the tether is connected to the ROV, and wherein the tether is configured to wirelessly transmit data and/or information from the ROV to the UAS. The system further includes a base station in communication with the UAS, the base station has a non-transitory computer readable medium having program instructions stored thereon; and a processor operable to execute the program instructions to wirelessly transmit and receive data and/or information from the UAS in real time when the ROV is deployed on or beneath the surface of the body of water.

In an embodiment, a method for transporting and deploying a payload, such as a remotely operated vehicle (ROV), wherein the method includes calibrating a base station and wirelessly connecting the base station with an unmanned aerial system (UAS). The method further includes flying the UAS from a first location and landing the UAS on a second location, wherein the second location is on a body of water; deploying the ROV from the UAS on or beneath the surface of the body of water using a winch and a tether; capturing, via the ROV, data and/or information from the body water; transmitting, via the tether, the data and/or information from the ROV to the UAS in real time; transmitting the data and/or information from the UAS to the base station; retrieving, using the winch and the tether, the ROV back to the UAS; and flying the UAS back to the first location.

In another embodiment, a computer-implemented method includes processing data and/or information captured from a payload positioned on or beneath the surface of a body of water, wherein the data and/or information is wirelessly transmitted to an unmanned aerial system (UAS) via a tether connected at one end to the payload and at another end to the UAS; analyzing the data and/or information to determine when to retract the payload from the surface or beneath the surface of the body of water to the UAS; and transmitting the data and/or information from the UAS to a remote base station.

### BRIEF DESCRIPTION OF THE DRAWINGS

The above, as well as other advantages of the present disclosure, will become readily apparent to those skilled in the art from the following detailed description when considered in light of the accompanying drawings in which:

FIG. 1 illustrates a schematic perspective view of a system including an unmanned aerial system (UAS) for transporting and deploying a remotely operated vehicle (ROV) underwater according to an embodiment of the disclosure;

FIG. 2 illustrates a schematic top, perspective view of the UAS as illustrated in FIG. 1 deploying the ROV underwater;

FIG. 3 illustrates a schematic bottom, perspective view of the UAS as illustrated in FIGS. 1 and 2 deploying the ROV underwater;

FIG. 4 illustrates a schematic exploded view of the UAS and the ROV as illustrated in FIGS. 1-3;

FIG. 5 illustrates a schematic front view of the UAS and the ROV as illustrated in FIGS. 1-4;

FIG. 6 illustrates a schematic bottom plan view of the UAS and the ROV as illustrated in FIGS. 1-5;

FIG. 7 illustrates a schematic top plan view of the UAS and the ROV as illustrated in FIGS. 1-6;

FIG. 8 illustrates a schematic sectional view of the UAS and the ROV as illustrated in FIGS. 1-7;

FIG. 9 illustrates a schematic exploded view of the ROV without the UAS as illustrated in FIGS. 1-8;

FIG. 10 illustrates a schematic isometric view of a winch and tether assembly as illustrated in FIGS. 2-4;

FIG. 11 illustrates a schematic perspective view of a slip ring on the winch and tether assembly as illustrated in FIG. 10; and

FIG. 12 illustrates a flow chart depicting an exemplary method for deploying the ROV underwater using the system as illustrated in FIG. 1.

### DETAILED DESCRIPTION

It is to be understood that the disclosure may assume various alternative orientations and step sequences, except where expressly specified to the contrary. It is also understood that the specific devices and processes illustrated in the attached drawings, and described in the specification are simply exemplary embodiments of the inventive concepts disclosed and defined herein. Hence, specific dimensions, directions or other physical characteristics relating to the various embodiments disclosed are not to be considered as limiting, unless expressly stated otherwise.

Certain embodiments are described as including logic or a number of routines, subroutines, applications, or instructions. These embodiments may constitute either software (e.g., code embodied on a machine-readable medium) and/or hardware, depending on the context.

As used herein, the terms “unmanned aerial system,” “UAS,” “unmanned aerial vehicle,” “UAV,” and drone may refer to any autonomous or semi-autonomous vehicle that is capable of performing some functions without a physically present human pilot.

As used herein, the terms “ROV” and “remotely operated vehicle” refer to a payload on the UAS. As used herein, the term “payload” refers to the weight a UAS can carry. It includes anything additional the UAS, such as cameras, sensors, or other attachments.

Systems and methods for transporting, deploying, and retrieving a subsea ROV by a UAS are provided herein. The UAS may be flown from an original locations to location in the water, where the UAS may land on the water and deploy a ROV under the water. The UAS may then return to its original takeoff location. The systems and methods disclosed herein may be used for a variety of applications, including, but not limited to marine inspection, search and recovery operations, and military.

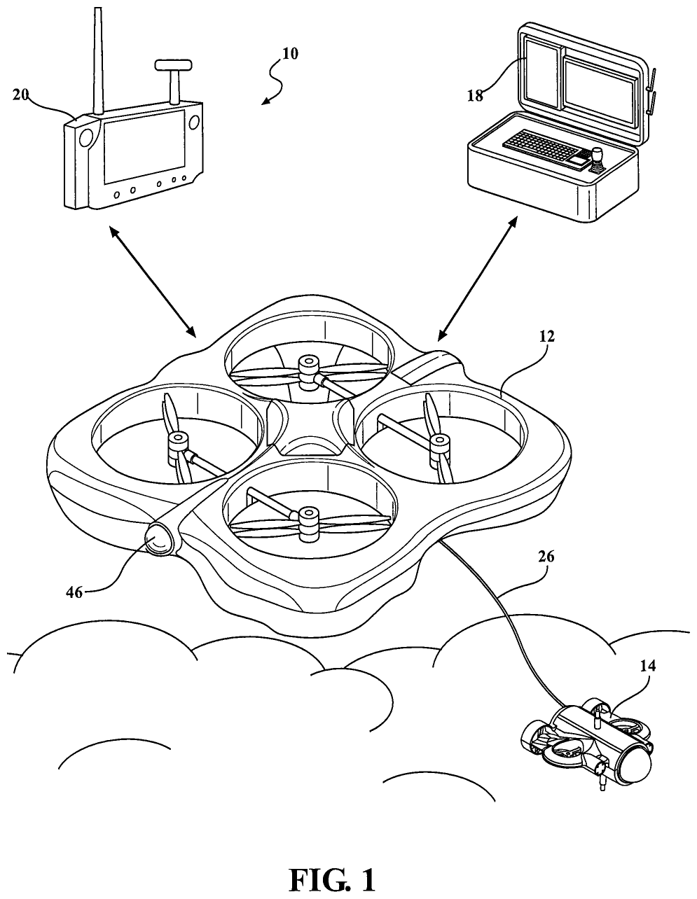

FIG. 1 is a perspective view of a system 10 including a UAS 12 for transporting and deploying a payload (e.g. ROV) 14 according to an embodiment of the disclosure. The UAS 12 is configured to fly from one location to another, to land on water, to deploy the ROV 14 underwater using a winch and tether assembly 16, to collect the ROV 14 and to fly back to its original takeoff location. One of ordinary skill in the art would appreciate that the ROV 14 may take on a variety of different sizes and configurations so long as the ROV 14 can still be transported, deployed, and retrieved by the UAS 12.

The system 10 is easily transportable as all of its components can readily fit into a transport case. Each of the components may be provided together as part of the system 10 or each of the components, such as the UAS 12 and the ROV 14, may be packaged and provided individually.

The UAS 12 is also configured to act as a communications hub for the ROV 14, wherein the UAS 12 communicates directly with a remote base station 18. The base station 18 may receive data from and transmit data to the UAS 12 pertaining to real-time telemetry, video, and/or the operation of the UAS 12. The UAS 12 may send and receive data using RFD 900 radio modems or other long-range communication devices. Data transmitted to the base station 18 may be recorded and stored on a drive of the base station 18. The UAS 12 is also configured to store data using an internal computing system and send information in real time to the cloud or to other Internet-based locations.

The UAS 12 may also relay signals received from the base station 18 to the ROV 14 using the winch and tether assembly 16, The UAS 12 and the ROV 14 may be controlled by an operator using a controller 20, such as a wireless controller. The controller 20 may comprise any known computing device, such as a tablet, phone, laptop, PC, or the like. The operator may control both the UAS 12 and the ROV 14 simultaneously using various techniques and/or protocols, such as SBUS protocol.

The UAS 12 includes one or more communications systems 22. The communication systems 22 may include one or more wireless interfaces and/or one or more wireline interfaces that allow the UAS 12 to communicate via one or more networks. Such wireless interfaces may provide for communication under one or more wireless communication protocols, such as Bluetooth, Wi-Fi, LTE, RFID protocol, and/or other wireless communication protocols. Examples of wireline interfaces include an Ethernet interface, a USB interface, or similar interfaces to communicate via a wire, or other physical connection.

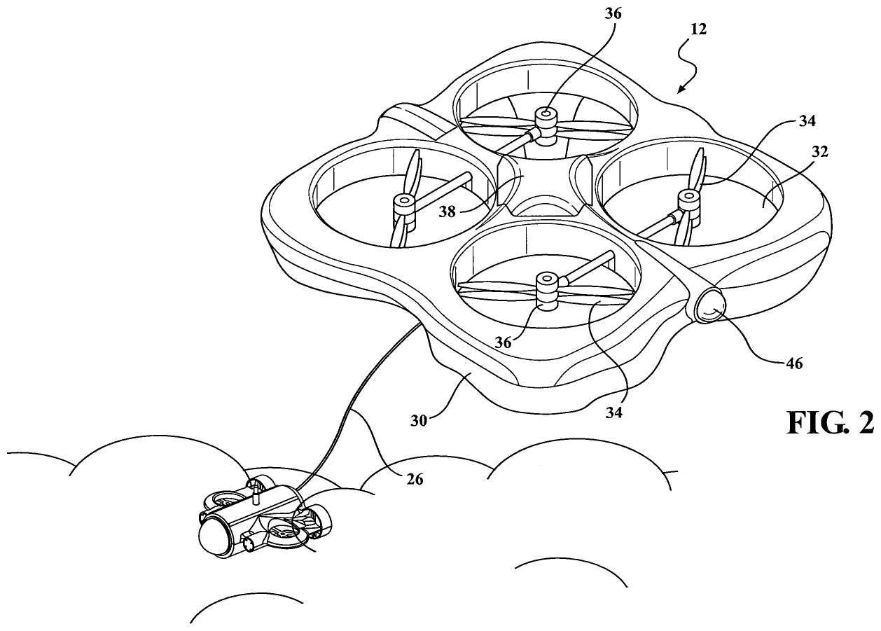

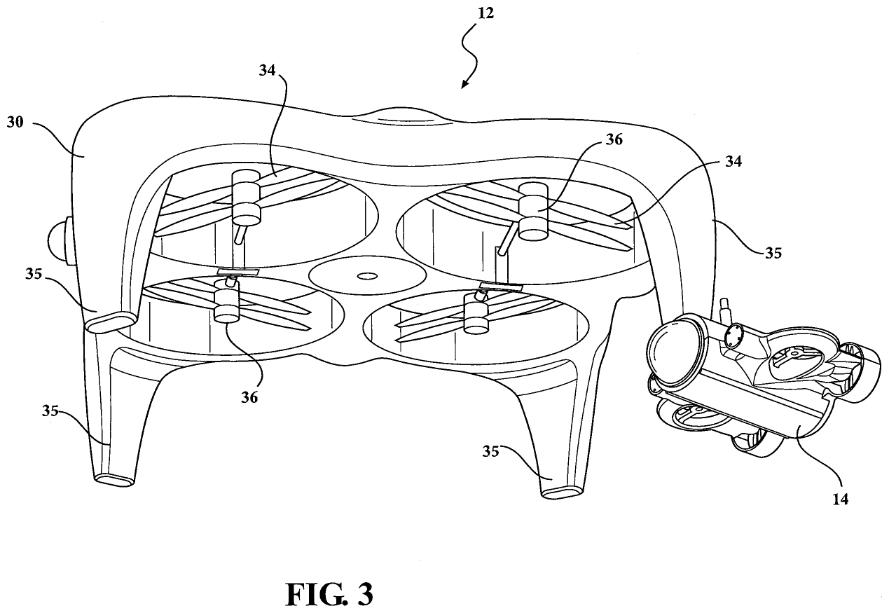

FIGS. 2 and 3 show views of the UAS 12 deploying the ROV 14 underwater using the winch and tether assembly 16 positioned within the UAS 12. The UAS 12 may autonomously land on a water surface and remain on the surface of the water as the ROV 14 is deployed from the UAS 12 to a desired location either on the surface of the water or beneath the surface of the water. In some embodiments, the ROV 14 may be deployed to 500 feet or more below the surface of the water.

The winch and tether assembly 16 comprises a winch 24 (as described in more detail below) and a flexible fixture, such as a tether 26. The winch 24 is configured to unreel and reel in the tether 26 to lower and raise the ROV 14 in a controlled manner with accurate movement. The ROV 14 may be retracted to the UAS 12 by reeling in the tether 26 using the winch 24. However, other examples of tether anchors are also possible herein.

The tether 26 may be formed from a variety of materials, including, but not limited to polymeric fibers, metallic and/or synthetic cables, and other materials that exhibit high tensile strength per unit weight. The tether 26 is also operable for transmitting data and information between the ROV 14 and the UAS 12. The tether 26 may include, or be coupled to, a data-transmission wire and/or a fiber optic line. In some embodiments, the tether 26 may have a wire gauge of about 26 AWG and a voltage rating of about 300 VDC.

In an embodiment, the ROV 14 is configured to surface above the water and to transmit a signal to the base station 18 notifying the base station 18 of its location when the tether 26 is broken or disconnected. In another embodiment, the ROV 14 is configured to navigate back to the UAS 12 and/or to the base station 18 when the tether 26 is broken or disconnected.

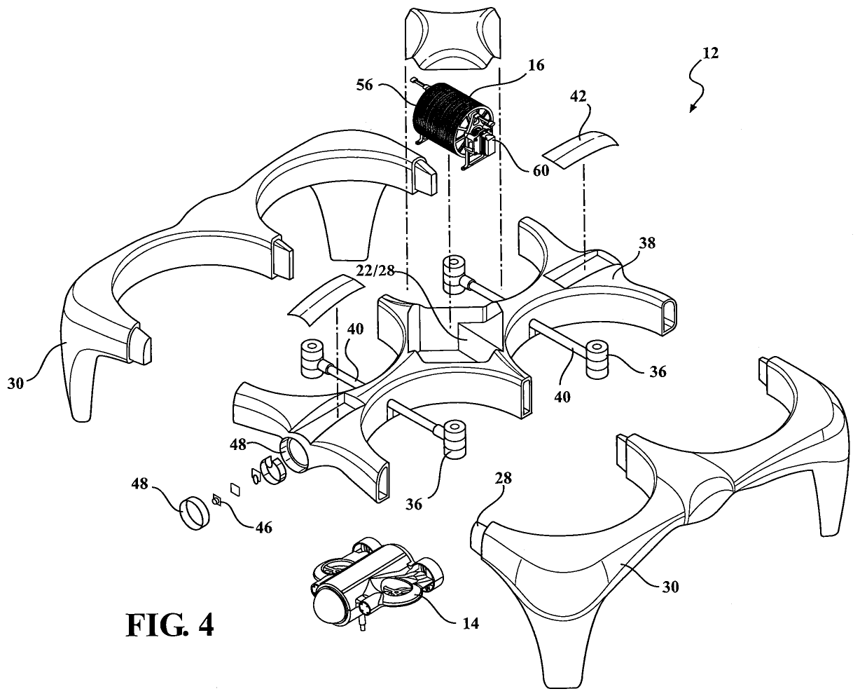

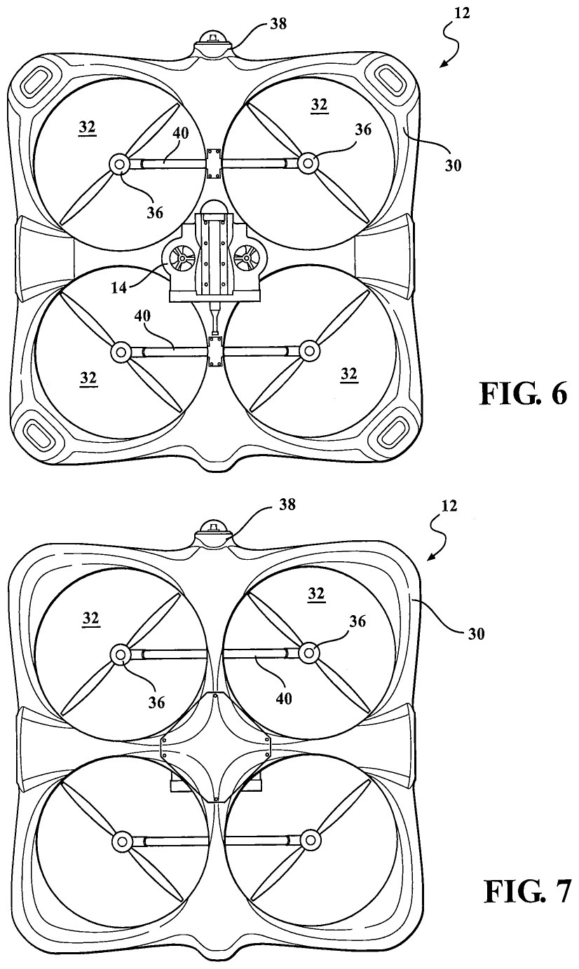

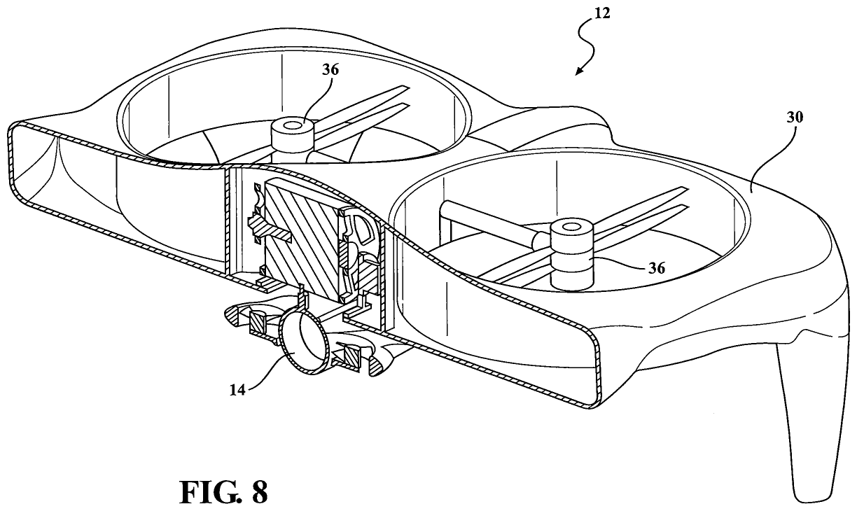

As best seen in FIGS. 4, 6, and 8, an ROV support structure 28 is housed within a frame 30 of the UAS 12. The support structure 28 may be configured to hold and stabilize a portion of the ROV 14 near the bottom of the frame 30 during flight of the UAS 12 from a first (launch) location to a second (target) location on the water. The target location may be a location on the surface of the water located above a desired ROV deployment location beneath the surface of the water.

When the UAS 12 reaches the target location, the UAS's control system may operate the winch and tether assembly 16 such that the ROV 14 is suspended by the tether 26 beneath the surface of the water. Upon completion of its programmed mission as directed by the base station 18, the ROV 14 may be retrieved by the winch and tether assembly 16 and added back to the UAS 12.

After being deployed onto or beneath the surface of the water, the ROV 14 may gather various types of telemetry, data, and/or information in a subsea environment. Examples of such data and information comprises GPS location, water depth, water temperature, and images/videos of structures, surfaces, aquatic wildlife and the like. The telemetry, data, and information captured by the ROV 14 may be wirelessly transmitted in real-time to the UAS 12 using the tether 26 and then to the base station 18 via the controller 20. As a result, the UAS 12 acts as a communications relay between the operator and subsea operations once it has landed on the water surface and deployed the ROV 14. Using the base station 18, the operator may remotely control both the ROV 14 and the UAS 12.

The UAS 12 may include a processing system 25 configured to provide various functions described herein. The processing system 25 may include or take the form of program instructions stored in a non-transitory computer-readable medium (e.g., memory) and may also include a variety of functional modules implemented by software, firmware, and/or hardware. The processing system 25 may include one or more microprocessors in communication with the memory. In practice, the processing system 25 may cause the winch and tether assembly 16 to perform certain functions by executing program instructions stored in memory. The memory is configured to store data and information received from the ROV 14.

In some embodiments, the system 10 may be configured to detect specific conditions associated with the target location on the water, such as waves, obstacles in the water, etc.

In an alternative embodiment, a wireless ROV may be deployed underwater using a floatable buoy, wherein the buoy has the same components as the UAS 12. In another alternative embodiment, a ROV may be deployed underwater from a boat, such as a remoter-controlled boat.

In some embodiments, the ROV 14 may be stored in a trunk or a backpack and readily deployed underwater directly from the trunk or the backpack by an operator, without the use of a UAS.

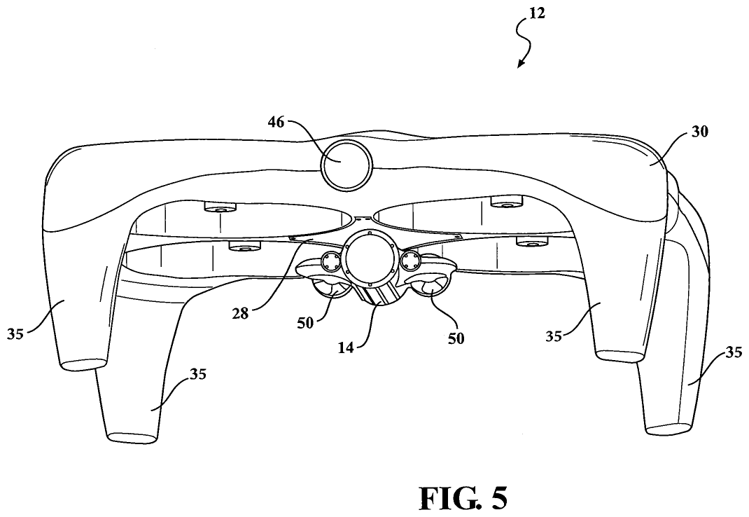

Referring to FIGS. 4-8, the UAS 12 comprises a structural frame 30 that is configured to float on water. The frame 30 may be made from a variety of suitable materials including, but not limited to carbon fiber, low-density foam, plastic, and any combinations thereof. The frame 30 may have any suitable configuration, shape, or size. In the embodiment shown in FIG. 4, the frame 30 may be constructed by the attachment of two opposing portions, where a main body 38 is interposed therebetween. The attachment of the portions of the frame 30 to the main body 38 defines a plurality of openings 32 therein. In an alternative embodiment, the frame 30 may be constructed from a monolithic structure.

As best seen in FIGS. 3-5 and as a non-limiting example, the frame 30 comprises four spaced-apart legs 35 on each side of the frame 30. The result is two sets of legs 35 positioned along the exterior of the frame 30. One of ordinary skill in the art would appreciate that there may either be less than four or more than four legs 35 in other embodiments of the frame 30. The legs 35 are configured to break the surface tension of water when the UAS 12 lands on water and when the UAS 12 takes off from the water. This allows the UAS 12 to float on the surface of the water and reduces the amount of power needed for the UAS 12 to takeoff from the surface of the water.

One or more rotors 34, such as wings, blades, propellers, paddles, etc., may be positioned directly on one or more motors 36 within the openings 32. Each of the motors 36 may be attached to interior portions of the main body 38 via a plurality of shafts 40. Each of the motors 36 is configured to drive a rotor 34 in order to provide aerodynamic lift to move the UAS 12. In the embodiment shown in FIGS. 1-7, there are four motors 36 driving four rotors 34. As such, the motors 36 may receive signals indicating the rotors 34 need to be sped up (e.g. to generate lift) or slowed down (e.g. to descend). However, one of ordinary skill in the art would appreciate that a UAS may include more or less than four motors and rotors.

In an alternative embodiment, the UAS 12 may comprise a fixed wing configuration, instead of having a plurality of rotors. The fixed wing configuration may be configured for different payloads and for different types of environments.

As seen in FIG. 4, the winch and tether assembly 16 is mounted within a casing on the main body 38 in between two sets of the motors 36 and the rotors 34. The winch and tether assembly 16 may be positioned adjacent to the processing system 25 on the main body 38. A servo 60 is positioned adjacent to the winch and tether assembly 16 on the main body 38. The servo 60 is configured to ensure that the desired effect is being generated from the winch and tether assembly 16.

At least one of the portions of the frame 30 includes one or more power supply compartments 42 for housing one or more power supplies, such as batteries, therein. The batteries may be charged with electrical energy. In an exemplary embodiment, each of the batteries may be 22 amp batteries and may be lithium polymer batteries.

The UAS 12 further comprises one or more sensors (not shown), such as one or more accelerometers, gyroscopes, GPS, velocity sensors, magnetometers, barometers, encoders, and the like. In an embodiment, one or more sensors are housed within the controller 20 of the ROV 14. The sensors may be used for a variety of purposes, such as measuring the positioning/location of the UAS 12 and/or the ROV 14 and the altitude of the UAS 12 and underwater depth of the ROV 14. For example, by sensing changes in the location of the ROV 14 underwater, the winch and tether assembly 16 may trigger an earlier retrieval of the ROV 14 back to the UAS 12. In some embodiments, sonar actuators, samplers, and/or any combinations thereof may be positioned on the UAS 12 and/or the ROV 14.

As seen in FIGS. 4, 5, and 8 and as a non-limiting example, the UAS 12 also comprises an imaging device 46 mounted in an imaging device housing 48, such as a gimbal mount, to orient the imaging device 46 with respect to the orientation of the UAS 12 and/or the ground. The imaging device housing 48 permits tilting and orienting of the imaging device 46. In an embodiment, the imaging device 46 is mounted to a front portion of the main body 38. The imaging device 46 is configured to acquire and/or transmit one or more images and/or videos. Examples of the imaging device 46 include a camera, a video camera, a thermal camera, a gas detection camera, or any device having the ability to capture optic signals. The imaging device 46 may also include lights, such as LED lights.

As seen in FIGS. 4, 6, 8, and 9, the ROV 14 is configured as a payload for capturing image, videos, and/or other data about particular locations on or below the surface of water. One of ordinary skill in the art would appreciate that the ROV 14 may comprise a variety of sizes and configurations. In an embodiment, the ROV 14 weighs between about 5 and 20 pounds and has a positive buoyance in salt water and a neutral buoyancy in fresh water.

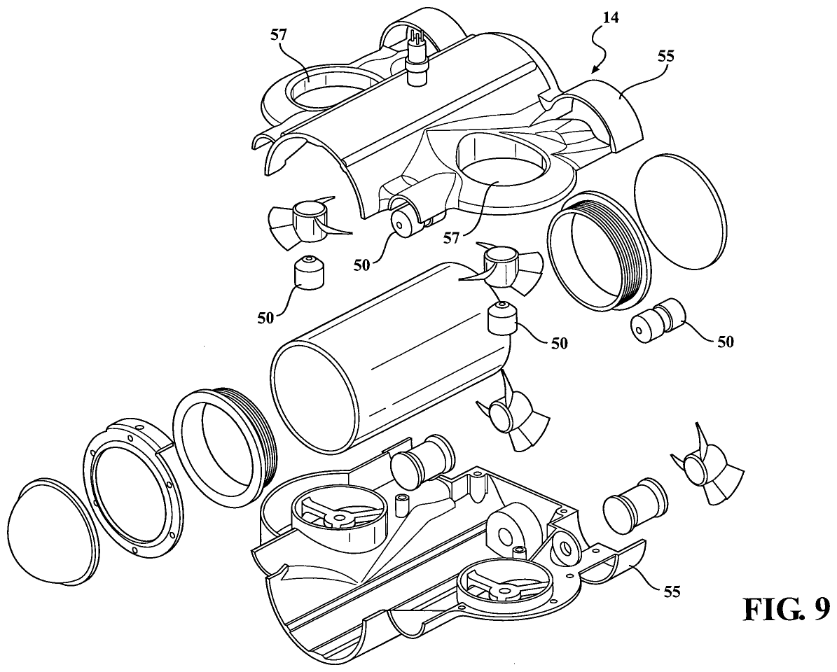

As seen in FIG. 9, the ROV 14 may include one or more thrusters 50 that are configured to help propel the ROV 14 in water. In an embodiment, the ROV 14 includes two vertical and two horizontal thrusters 50.

The ROV 14 also comprises a rail system 55 defining a plurality of apertures 57. In the embodiment shown in FIG. 9, the ROV 14 includes two opposing apertures 57. The apertures 57 are configured to act as a passive ballast when the ROV 14 is deployed. Specifically, the ROV 14 may fill with water and drain water in flight for weight conservation. The rail system 55 may include two components that are attached together or may be made up of one monolithic component. In some embodiments, the rail system 55 may receive equipment, such as sediment samplers, sonar actuators, and/or water quality attachments.

The ROV 14 also comprises one or more imaging devices, such as cameras and lights. The cameras on the ROV 14 may tilt up to 180 degrees to allow for full capture of images, video, and data on or below the surface of the water. As noted above, the ROV 14 also includes one or more sensors mounted thereon. The sensors are configured to obtain and transmit data and/or information to the UAS 12 via the tether 26. This data and/or information may then be transmitted to the base station 18.

The ROV 14 further comprises one or more power supply units, such as lithium ion batteries.

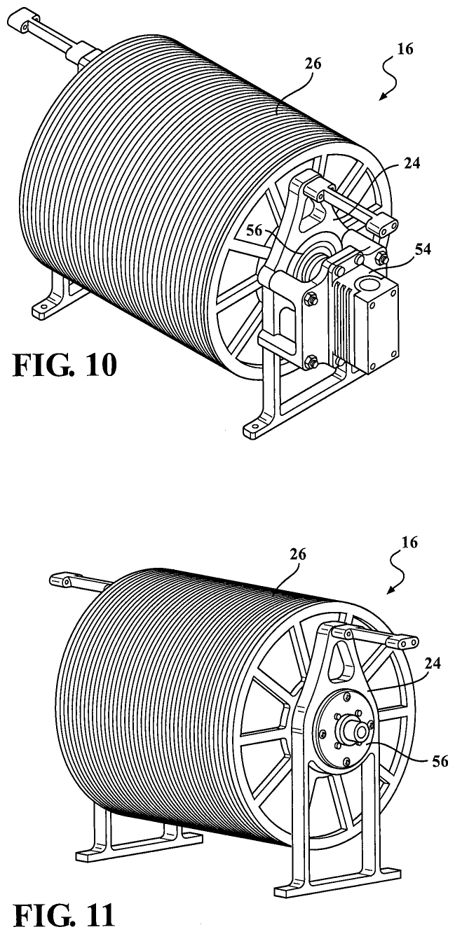

FIGS. 10 and 11 show views of the winch and tether assembly 16 positioned within the UAS 12. The winch 24 is configured to wind/unwind a portion of the tether 26 coiled around the winch 24. The winch 24 comprises a rotatable spool portion 52 that may be rotated through a crank shaft connected to the spool portion 52. When the ROV 14 is not deployed from the UAS 12, the tether 26 is wound on the spool portion 52, as shown in FIGS. 10 and 11. When the ROV 14 is deployed from the UAS 12, the tether 26 is extended beneath the surface of the water while remaining connected at one end to the UAS 12 and at the other end to the ROV 14, as shown in FIGS. 2 and 3. This allow for the ROV 14 to dive to depths of up to about 500 feet below the water surface.

The winch 24 may be made from a low-density aluminum material. The winch 24 may comprise one or more motors 54 for retracting and deploying the ROV 14 or a secondary payload via the tether 26. As best seen in FIG. 11, the winch 24 includes an electrical rotary joint, such as slip ring 56, at one end of the spool portion 52. The electrical rotary joint is configured to transmit power and electrical signals to the winch 24.

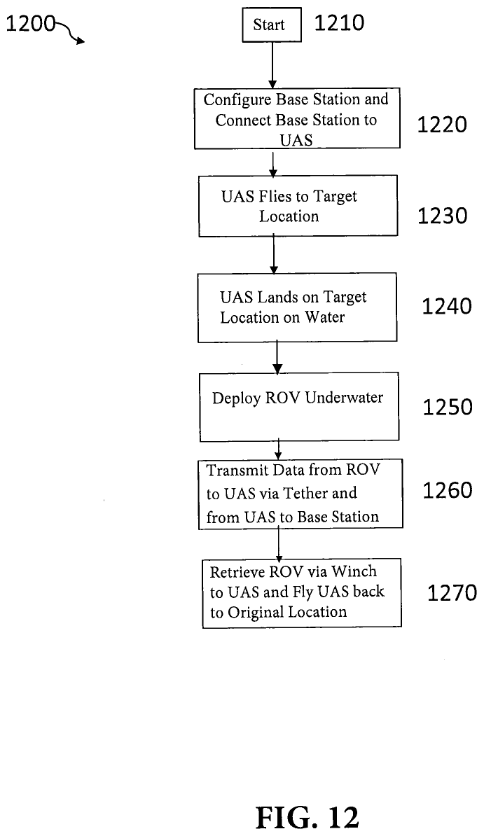

FIG. 12 shows a method 1200 for deploying the ROV 14 from the UAS 12 beneath the water surface using the system 10 described herein. The method 1200 begins at a start state 1210 and proceeds to block 1220 where the base station 18 is configured/calibrated. Communication, such as wireless communication, is also established between the base station 18 and the UAS 12 during block 1220. Further, the operator of the UAS 12 completes all preflight checks, including ensuring there is full video, telemetry, and connection between the base station 18 and the UAS 12.

Next, at block 1230, the UAS 12 leaves its original location and flies on a mission to a target location as directed by the base station 18. The flight of the UAS 12 may be automated or manually controlled. Next, the UAS 12 lands on its target location on the water, as shown in block 1240.

As shown in block 1250, the UAS then deploys the ROV 14 beneath the surface of the water using the winch and tether assembly 16. The ROV 14 gathers information and/or data in a subsea environment and captures it using its cameras and/or sensors. The captured data is then transmitted to the UAS 12 via the tether 26, as shown in block 1260. The data may then be transmitted from the UAS 12 to the controller 20 and/or the base station 18. The data may be transmitted in real-time or near real-time and may be wirelessly transmitted or through a wired connection.

Once the data collection in the subsea environment is completed, the winch 24 retrieves the ROV 14 back to the frame 30 of the UAS 12 and the UAS 12 flies back to its original, takeoff location, as shown in block 1270.

The system 10 and method 1200 for the underwater deployment of the ROV 14 using the UAS 12 offer significant benefits over existing systems and processes, including the ability to operate from a single base station 18 that is capable of single pilot operation and the rapid landing of the UAS 12 on the water and deployment of the ROV 14 beneath the water without requiring a dive team. As a result, the system 10 is much safer to use for divers and pilots. Other benefits include the ability for the system 10 to work in various environmental conditions, such as high wind and heavy seas and the ability to go beyond visual line of sight.

It is to be understood that the various embodiments described in this specification and as illustrated in the attached drawings are simply exemplary embodiments illustrating the inventive concepts as defined in the claims. As a result, it is to be understood that the various embodiments described and illustrated may be combined from the inventive concepts defined in the appended claims.

In accordance with the provisions of the patent statutes, the present disclosure has been described to represent what is considered to represent the preferred embodiments. However, it should be noted that this disclosure can be practiced in other ways than those specifically illustrated and described without departing from the spirit or scope of this disclosure.

What is claimed is:

1. A system comprising:
an unmanned aerial system (UAS) comprising:
a support structure configured to receive a payload, wherein the payload is configured to deploy from the support structure to a location on or beneath the surface of a body of water;
a winch configured to selectively deploy the payload from the support structure using a flexible fixture comprising a first portion and a second portion, wherein the first portion of the fixture is connected to the UAS and the second portion of the fixture is connected to the payload, and wherein the fixture is configured to wirelessly transmit data and/or information from the payload to the UAS;
a first processor configured to receive and analyze data and/or information transmitted from the payload via the flexible fixture; and
a base station in communication with the UAS, the base station comprising:
a non-transitory computer readable medium having program instructions stored thereon; and
a second processor operable to execute the program instructions to wirelessly transmit and receive data and/or information from the UAS or the flexible fixture when the payload is deployed on or beneath the surface of the body of water.

2. The system of claim 1, wherein the payload is a remotely operated vehicle (ROV) and the flexible fixture is a tether.

3. The system of claim 1, wherein the support structure is housed within a frame of the UAS, and wherein the UAS frame comprises a plurality of spaced-apart legs allowing the UAS frame to float on the body of water.

4. The system of claim 3, wherein the UAS frame defines one more openings, and wherein one or more rotors are positioned on one or more motors within the one or more openings.

5. The system of claim 1, wherein the UAS further comprises one or more sensors and one or more cameras, wherein at least one of the sensors is positioned within the payload.

6. The system of claim 2, wherein the payload comprises one or more thrusters and wherein the thrusters are configured to propel the payload in the body of water.

7. The system of claim 2, wherein the ROV comprises a rail system defining a plurality of opposing apertures, wherein the rail system is interposed between the plurality of apertures.

8. The system of claim 1, wherein the winch comprises a spool, and wherein the flexible fixture is wound on the spool when the payload is mounted to the support structure.

9. The system of claim 8, wherein the winch comprises one or more motors and an electrical rotary joint at one end of the spool.

10. The system of claim 1, wherein the payload is configured to communicate directly with the base station when the flexible fixture is broken or disconnected.

11. The system of claim 2, wherein the tether comprises a data-transmission wire and/or a fiber optic line.

12. A method for transporting and deploying a payload, the method comprising:
calibrating a base station and wirelessly connecting the base station with an unmanned aerial system (UAS);
flying the UAS from a first location and landing the UAS on a second location, wherein the second location is on a body of water;
deploying the payload from the UAS on or beneath the surface of the body of water using a winch and a tether;
capturing, via the payload, data and/or information from the body water;
transmitting, via the tether, the data and/or information from the payload to the UAS in real time;
transmitting the data and/or information from the UAS to the base station;
retrieving, using the winch and the tether, the payload back to the UAS; and
flying the UAS back to the first location.

13. The method of claim 12, wherein the payload is a remotely operated vehicle (ROV).

14. The method of claim 12, wherein data and/or information is captured using one or more cameras and one or more sensors on the payload.

15. The method of claim 12, wherein the tether comprises a first portion and a second portion, wherein the first portion of the tether is connected to the UAS and the second portion of the tether is connected to the payload.

16. The method of claim 12, wherein the payload is deployed from a support structure housed within a frame of the UAS.

17. A computer-implemented method comprising:
processing data and/or information captured from a payload positioned on or beneath the surface of a body of water, wherein the data and/or information is wirelessly transmitted to an unmanned aerial system (UAS) via a tether connected at one end to the payload and at another end to the UAS;
analyzing the data and/or information to determine when to retract the payload from the surface or beneath the surface of the body of water to the UAS; and
transmitting the data and/or information from the UAS to a remote base station.
